(19) United States
(12) Patent Application Publication
(10) Pub. No.: US 2013/0193320 A1
(43) Pub. Date: Aug. 1, 2013

(54) Mass spectrometer with a wide dynamic range

(71) Applicants: Manuela Bergna, Monza (IT); Alessandro Casilli, Magadino (CH); Alberto Tommaso Crotti, Monza (IT)

(72) Inventors: Andrew Hoffman, Cologno Monzese (IT); Manuela Bergna, Monza (IT); Alessandro Casilli, Magadino (CH); Alberto Tommaso Crotti, Monza (IT)

(73) Assignee: DANI INSTRUMENTS S.P.A., Cologno Monzese (IT)

(21) Appl. No.: 13/496,293

(22) PCT Filed: Sep. 14, 2010
(86) PCT No.: PCT/EP2010/063478

§ 371 Date: Jun. 4, 2012

(30) Foreign Application Priority Data
Sep. 16, 2009 (IT) VE2009A000050

(51) Int. Cl. H01J 49/02

(52) U.S. Cl. CPC H01J 49/022
USPC 250/287; 250/288

(57) ABSTRACT

A mass spectrometer with a wide dynamic range, having:—a source (2) of ion beams,—an analyzer (4) for the ion beams generated by said source (2),—a detector (6) for the ions separated by said analyzer (4),—a treatment stage (8) for the analogue signal A generated by said detector, to obtain two separate signals A1=mA and A2=nA, where m>n, characterised by comprising:—an analogue/digital converter (10) for converting both said analogue signals A1 and A2 into two numerical values D1 and D2,—a controller (12) which receives both the numerical values D1 and D2 as input, and provides as output a single value equal to D1 if D1 is less than the end-of-scale value of the converter (10), or a value equal to (m/n)D2 if D1 is equal to the end-of-scale value of the converter.

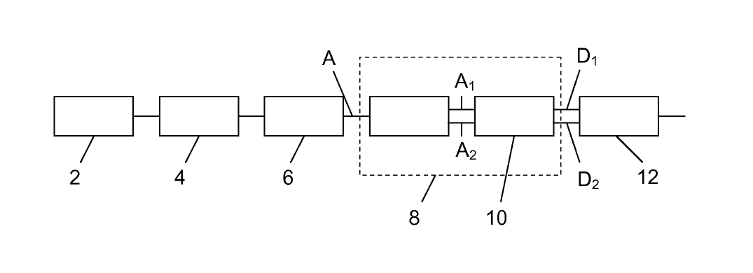

The present invention relates to a mass spectrometer with a wide dynamic range.

Mass spectrometers are known in which the ratio M/Z between the mass and the charge of the ions of the various substances to be analyzed is determined by measuring the time taken by the ions to pass through a chamber connecting the source to the detector.

The invention relates in particular to the manner in which the signal generated by the ions and detected by the detector is manipulated before being fed to a controller for its utilization.

The analogue signal detected by the detector is fed to an electronic treatment circuit for conditioning before being fed to the analogue/digital converter for its digitization.

This operation does not always prove satisfactory, as the complex mixtures to be analyzed often contain species having concentrations which differ by several orders of magnitude. The term “dynamic range” means the number of orders of magnitude which the mass spectrometer is able to detect. For example a mass spectrometer able to detect components of a mixture which are present in concentrations between 10⁻¹ and 10⁴ is defined as a mass spectrometer with a dynamic range of three orders of magnitude.

Those mass spectrometers with a single detector are currently unable to have dynamic ranges with more than three or four orders of magnitude, this representing a limit on the performance of the apparatus, which is unable to detect in complex mixtures the presence of substances within a wide range of concentrations.

U.S. Pat. No. 5,926,124 describes a signal processor for a measurement apparatus, in which two differently amplified analogue signals originating from a detector are fed to an A/D converter via two separate analogue selectors. Only one of the two analogue signals at a time reaches the A/D converter due to the activation of only one of the two separate analogue selectors by a microprocessor, on the basis of a comparison between the digitized value returned by the A/D converter and predefined reference thresholds relative to the end-of-scale and start-of-scale values of the A/D converter.

This solution results in an increase in the dynamic range of a measuring apparatus, and in particular of a mass spectrometer, but has the drawback of not being usable with apparatus operating at high or very high acquisition frequencies, with which the switching times of the analogue selector could be incompatible. Moreover it results in the loss of sampling points when the digitized value exceeds the predefined saturation threshold of the A/D converter, the microprocessor being obliged to switch the analogue selectors to obtain a lower gain in order to prevent saturation or, conversely, when the digitized value is less than the predefined start-of-scale value, the microprocessor being obliged to switch the analogue selectors to more greatly amplify the signal; this represents an important limitation for the measuring apparatus when the signal, being close to those values which cause the analogue selectors to switch, is irregularly subjected to frequent switchings which determine a high loss of sampling points.

An object of the invention is to provide a mass spectrometer which has a dynamic range of at least one order of magnitude greater than that of traditional mass spectrometers, and is without the aforestated drawbacks.

This and other objects which will be apparent from the ensuing description are attained, according to the invention, by a mass spectrometer with a wide dynamic range, as described in claim 1.

The present invention is further clarified hereinafter with reference to the accompanying drawing showing a block diagram of a mass spectrometer according to the invention.

As can be seen from the diagram, the mass spectrometer of the invention comprises a source 2 of ion beams to be fed to an analyzer 4 connected to a detector 6 able to generate an analogue signal A.

Downstream of the detector 6 a signal treatment and conversion stage, indicated overall by 8, is provided with the purpose of splitting the signal A from the detector 6 into two signals A1=mA and A2=nA, where m>n, hence where A1=(m/n)A2, and of converting the two analogue signals A1 and A2 obtained in this manner into two numerical values D1 and D2.

In practice, the treatment and conversion stage 8 comprises two operational amplifiers suitably configured to achieve gains m and n respectively, and an analogue/digital converter 10 with two analogue inputs connected to the two signals generated by the two operational amplifiers and with an output digital signal bus which enables the numerical values D1 and D2 obtained within the converter to be transmitted to the outside.

The digital bus is connected to a digital controller 12, the function of which is to make a choice between the two values D1 and D2 on the basis of the value of D1: specifically, if D1 is less than the digital end-of-scale value of the converter 10, the controller 12 chooses the value D1; if however D1 is equal to the end-of-scale value of the converter 10, it chooses the value D2 multiplied by the ratio m/n.

To better describe the present invention by means of a concrete example, it can be stated that the treatment stage 8, which can generally provide amplification or attenuation of the input signals, generates a signal A1 equal to twice A (m=2) and a signal A2 eight times more attenuated than the signal A (n=1/8).

In the analogue/digital converter 10, both the signals A1 and A2 are sampled at the prescribed frequency (e.g. 600 MHz) and are transformed into numerical values with 8 bit resolution, i.e. with values between 0 and 255, expressing for each unit variation 1/256 of the end-of-scale value of the converter 10.

As stated, the function of the controller 12 positioned downstream of the converter 10 is to make a choice between the two values D1 and D2 on the basis of their size. Specifically, if D1 is less than 255, the controller 12 chooses that value and discards D2. If instead D1=255, representing the digital end-of-scale value of the converter 10, this means that the signal A1 saturates the converter and hence the numerical value D1 obtained is no longer representative of the original signal A1. In this case the controller 12 discards it, chooses the value D2 and multiplies it by the numerical value 16, i.e. the ratio m/n, to enable it to be compared with the value D1, which uses a multiplication factor for the original analogue signal which is 16 times greater.

Essentially, by virtue of this expedient, the range of detectable values, which in a traditional mass spectrometer using an analogue/digital converter with 8 bit resolution ranges from 0 to 255, now ranges from 0 to 255×16, i.e. from 0 to 4080, while still using an 8 bit analogue/digital converter. In the 0 to 255 value range the end-of-scale resolution is 1 over 4096 (i.e. 12 bit) whereas in the value range from 256 to 4080 it is 16 over 4096 (i.e. 8 bit).

In practice, the mass spectrometer according to the invention results in a resolution increment within the range towards the low analogue signal values, this range being bounded upperly by a signal value equal to n/m of the end-of-scale value of the converter. This increment in resolution, expressed in bits, compared with the resolution, expressed in bits, of the analogue/digital converter 10 is equal to log₂(m/n), i.e. 4 bit in the application considered.

The ability to increase the resolution of the analogue/digital converter finds an advantageous application in analyzers requiring high acquisition frequencies, which involve the use of low resolution analogue/digital converters. And as, in particular, TOF (time-of-flight) analyzers require high analogue signal sampling frequencies, hence involving the use of low resolution analogue/digital converters, the invention finds an advantageous application in mass spectrometers using TOF analyzers.

This resolution increment means that compared with traditional mass spectrometers, which at most can achieve a dynamic range of four orders of magnitude, the mass spectrometer of the invention presents a dynamic range of five orders of magnitude.

The invention claimed is:

1. A mass spectrometer with a wide dynamic range, having:
a source (2) of ion beams;
an analyzer (4) for the ion beams generated by said source (2);
a detector (6) for ions separated by said analyzer (4);
a state (8) for processing of an analogue signal A, generated by said detector, to obtain two separate analogue signals A1=mA and A2=nA, were m>n;
an analogue/digital converter (10); and
a controller (12), which selects between said analogue signals, a signal of interest,
wherein:
n and m are integer and fixed,
aid analogue/digital converter (10) converts both said analogue signals A1 and A2 into two numerical values D1 and D2,
said controller (12) receives both the numerical values D1 and D2 as input, and provides as output a single value equal to D1 if D1 is less than an end-of-scale value of said converter (10), or a value equal to (m/n)D2 if D1 is equal to the end-of-scale value of said converter.

2. The mass spectrometer as claimed in claim 1, wherein the analogue/digital converter (10) has a sampling frequency of an order of 10⁹ samplings per second and a resolution less than 12 bit.

3. The mass spectrometer as claimed in claim 1, wherein the stage (8) uses a m/n ratio of 16.

4. The mass spectrometer as claimed in claim 1, wherein the analyzer (4) is a time-of flight (TOF) analyzer.
